(19) United States
(12) Patent Application Publication
(10) Pub. No.: US 2006/0215012 A1
(43) Pub. Date: Sep. 28, 2006

(54) Method of and system for augmenting presentation of content

(75) Inventor: Boris Emmanuel Rachmund De Ruyter, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V. GROENEWOUDSEWEG 1, EINDHOVEN (NL)

(21) Appl. No.: 10/543,278

(22) PCT Filed: Dec. 18, 2003
(86) PCT No.: PCT/IB03/06373

§ 371 Date: Jul. 25, 2005

(30) Foreign Application Priority Data
Jan. 28, 2003 (EP) 03100168.8

(51) Int. Cl. H04N 7/14

(52) U.S. Cl. 348/14.08

(57) ABSTRACT

A method of augmenting presentation of content at a first location by projecting at first location a low-bandwidth visualization, i.e. a visualization in which presence information is rendered in an abstract form, of participation of viewers of the content at a second location, for example a projection of the silhouettes of the viewers at the second location, or a visualization of audio recorded at the second location. By allowing viewers at the first location to observe viewers at the second location, a feeling of social presence is generated for those first viewers. Also a system for augmented presentation of content at a first location, comprising presentation means for presenting the content, visualization means for creating a low-bandwidth visualization of participation of viewers of the content at a second location and projecting means for projecting the low-bandwidth visualization at the first location. The visualization means may comprise a camera or a microphone.

The invention relates to augmenting the presentation of content by providing a feeling of social presence to viewers of the content at different physical locations.

As connectivity technology evolves, the quest for user benefits of future appliances building on these technologies becomes critical. The introduction of advanced technologies such as interactive television has not resulted in the expected behavioral change of consumers. One of the most important causes for this was the absence of sufficient content to offer attractive user benefits. However, the creation of sufficient content for interactive television would only be attractive if enough consumers would use interactive television.

It is believed that consumers will only start investing in network enabled CE devices if their connectivity adds benefits for the consumers themselves. One such benefit is providing social presence. Social presence refers to the feeling of being together. Using connected CE devices, it should be possible to provide consumers with the feeling of being together while enjoying the same content from remote locations. As such, user benefits for connected CE devices could be created without the availability of special content, since the physical presence of users would be the content of network-connected appliances. As connectivity becomes more part of our lives and of our daily use of electronic devices, it is to be expected that network infrastructures will become an enabler for social interactions. Although applications such as chatting via the Internet and SMS via mobile phones exist, there is more to system-mediated communication and exchanging information. Another, fairly unexplored application is the creation of social presence for networked devices.

The concept of presence can be grouped broadly into categories: physical presence and social presence. Physical presence refers to the sense of physically being located somewhere. This can be achieved by providing people with virtual reality systems using devices like head-mounted displays, for example. Social presence, on the other hand, can be defined as the sense of being together (and communicating) with someone else. The focus is not on the sensation of being in another location but on the feeling of interacting with another person.

In social life people are part of many groups they interact with. The feeling of being a member of such a group is called group attraction. It is not always possible (or desirable) for the members of the group to physically visit each other and view a movie, a television program or some other content item together. It is thus desirable to provide group attraction between people who are viewing content at different physical locations. One known way to do this is to provide cameras at the respective locations, which record participation of the viewers at these locations. The recordings are then transmitted to the other locations where they can be watched so the viewers there can observe the recorded viewers. Although this creates some feeling of social presence, a negative aspect of this solution is that it also creates the feeling of being observed. Cameras in the home are very intrusive and tends to make people feel awkward in front of them. With the presented solution the use of a camera is required, hence the intrusiveness of a camera is still present. However, it is not so much the camera but the full image projection that is creating the perception of intrusiveness.

It is an object of the present invention to provide a technical way to provide a feeling of social presence to viewers of content at different physical locations which reduces the feeling of being observed.

This object is achieved according to the present invention in a method comprising projecting at first location a low-bandwidth visualization of participation of viewers of the content at a second location, and in a system comprising presentation means for presenting the content, visualization means for creating a low-bandwidth visualization of participation of viewers of the content at a second location and projecting means for projecting the low-bandwidth visualization at the first location.

By allowing viewers at the first location to observe viewers at the second location, a feeling of social presence is generated for those first viewers. Of course it is possible to simultaneously project at the second location a similar visualization of participation of viewers at the first location.

An essential aspect of the invention is that the visualization projected at the first location is a low-bandwidth visualization, i.e. a visualization in which presence information is rendered in an abstract form, for example a projection of the silhouettes of the viewers at the second location, or a visualization of audio recorded at the second location. An empirical study conducted by the inventor shows that a low-bandwidth visualization of activities at remote locations is capable of establishing a sense of social presence and a feeling of being part of a group (group attraction). At the same time, the low-bandwidth visualization was less distracting than a complete visualization of those activities. It also gave participants at the second location less the feeling of being observed by viewers at the first location than in a control group in which a full video recording and projection was used.

By itself, the article “AROMA: abstract presentation of presence supporting mutual awareness” by E. Pedersen and T. Sokoler, Proceedings of CHI '97, ACM, 1997, discloses a way to convey a sense of remote presence for the purpose of peripheral awareness. One embodiment uses degradation of a visual image to create a more abstract visualization at the remote location. However, this article is not concerned with augmenting the presentation of content or the creation of a feeling of social presence during simultaneous viewing of content at different physical locations.

In a preferred embodiment of the system, the visualization means comprise a camera arranged to record images of the viewers at the second location at predetermined intervals coupled to a visualizer arranged for computing a difference between two subsequent recorded images, which visualizer is in turn coupled to a transmitter for transmitting said difference to the projecting means, the projecting means being arranged to display the difference as the low-bandwidth visualization. An advantage of this embodiment is that only a small number of pixels needs to be transmitted which reduces the computational load in the visualizer and the projecting means. This way the silhouettes of the persons at the second location are displayed in a very simple yet effective way.

In a further preferred embodiment of the system, the visualization means comprise a microphone arranged to record audio at the second location coupled to a visualizer arranged to map the recorded audio to a color value on a given scale, which visualizer is in turn coupled to a transmitter for transmitting the color value to the projecting means, the projecting means being arranged to display a color corresponding to the color value as the low-bandwidth visualization.

Using a microphone instead of a camera also makes it possible to create a feeling of social presence. However, a microphone has the same disadvantages as a camera in that it also makes people feel awkward and feeling observed. By mapping the recorded audio to a color value on a given scale and displaying that color value instead of reproducing the recorded audio itself, the feeling of being observed is reduced substantially. Still, the feeling of social presence is provided in a sufficient manner since the colors being projected allow the viewers at the first location to learn about the feelings of the persons at the second location.

The invention will now be discussed with reference to the accompanying drawing, in which:

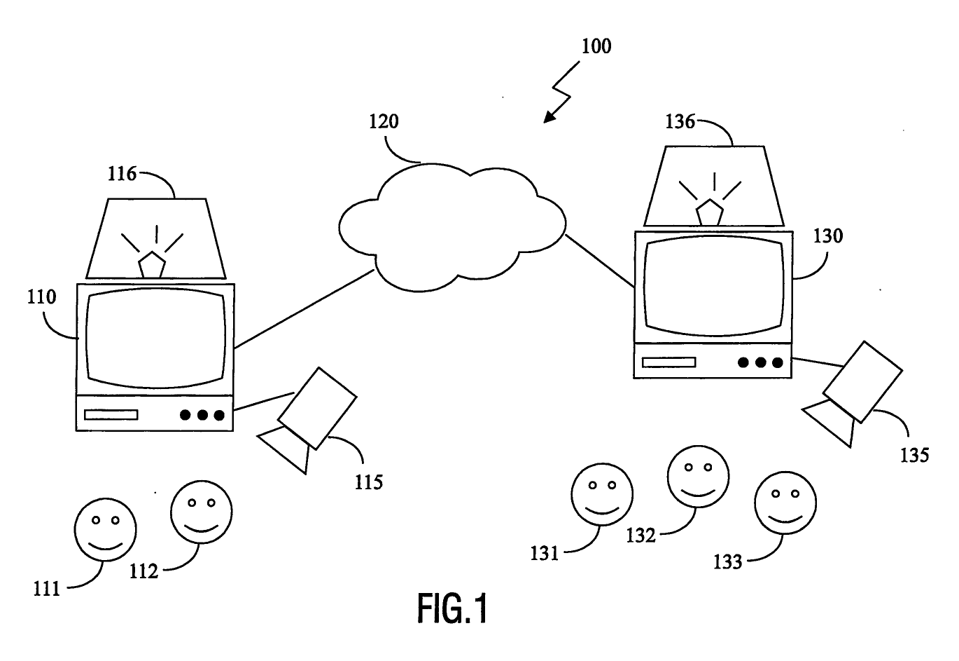

FIG. 1 schematically illustrates a preferred embodiment of the system according to the invention; and

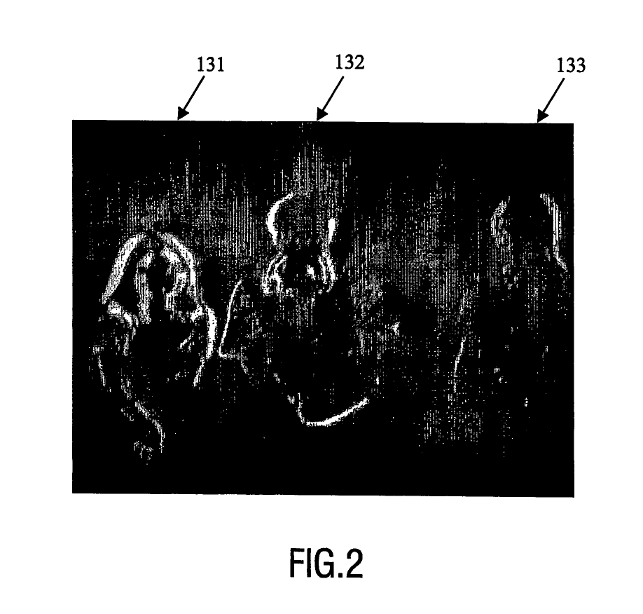

FIG. 2 illustrates a low-bandwidth projection in the form of a projection of silhouettes.

FIG. 1 schematically illustrates a system 100 comprising a first display device 110 and a second display device 130 interconnected via a network 120 such as the Internet. In the preferred embodiment, the display devices 110 and 120 comprise television receivers, although of course they can be any kind of device. For example, personal computers, radios, movie projection systems and so on could easily be substituted.

It is assumed that the first display device 1 10 is located at a first location and the second display device 130 is located at the second location, physically distinct from the first location. The devices 110,120 could be located in different rooms of the same house, in different houses in the same street, in different cities or even on different continents. Because of their connection via network 120 their physical distance does not matter.

Viewers 111 and 112 are viewing content being displayed on the first display device 110. At the same time, viewers 131, 132 and 133 are viewing the same content being displayed on the second display device 130. Camera 115 is provided to record images of the viewers 111, 112, and camera 135 is provided to record images of the viewers 131-133. Since the quality of the recorded images does not have to be very high, a cheap “webcam” suffices. The cameras 115, 135 are coupled to respective visualizers, which in this embodiment are implemented as software (not shown) running on a processor in the display devices 110 and 120. Also provided are projectors 116, 136 which in this embodiment are installed above the display devices 110 and 120. The projectors 116, 136 could also be installed behind the display devices 110 and 120 if they are large enough to allow the viewers to observe the images being projected thereon.

The visualizers receive images from the cameras at predetermined intervals, for example one image every second. The visualizer in the display device is compute a difference between subsequent images recorded by the camera connected to it . Typically this is done by subtracting pixel values at corresponding locations in the subsequent images. The deltas obtained in this way are transmitted to the projector connected to the display device at the other location. So deltas obtained from images recorded by camera 115 are transmitted from display device 110 to projector 136, and deltas obtained from images recorded by camera 135 are transmitted to projector 116. By only transmitting pixels that have changed between the subsequent images, a substantial savings in data transmission capacity required is obtained.

The projectors 116, 136 display the received data, which because of the way it is obtained results in a projection of the silhouettes of the viewers 131-133 and 111, 112 respectively being presented. An example of such a projection is illustrated in FIG. 2. Although it is possible from FIG. 2 to determine that the three viewers 131, 132, 133 are more or less passively observing the content being presented, it is not possible to observe these three viewers in detail to determine exactly who they are, how they are dressed and what they are doing exactly. Because of this, the three viewers do not have to feel observed.

An alternative to the use of cameras 115, 135 is to use microphones. These record audio at the first and second locations. The visualizers in the display devices 110, 120 receive the recorded audio and map it to a color value on a given scale. For example, the volume of the recorded audio could be mapped to a scale of 1 to 100. Many suitable alternatives exist. The color value is then transmitted to the projectors 116, 136 at the other location where a color corresponding to the received color value is displayed. This way, a change in the audio volume at the first location can be perceived at the second location by a change in color, for example because it changes from blue to red or because the intensity or brightness of the color changes in the way corresponding to the change in the audio volume. This alternative is very cheap to realize yet it is very effective because the color changes in the background can be observed easily even when watching a content item being presented on the display devices.

Other ways of visualizing audio recorded at the first or second locations are of course also possible. Using a microphone instead of a camera is less intrusive yet it allows the adequate creation of a feeling of social presence.

1. A method of augmenting presentation of content at a first location by projecting at first location a low-bandwidth visualization of participation of viewers of the content at a second location.

2. The method of claim 1, in which the low-bandwidth visualization comprises a projection of the silhouettes of the viewers at the second location.

3. The method of claim 2, in which the projection of the silhouettes is projected behind a display on which the content is presented at the first location.

4. The method of claim 2, in which the projection of the silhouettes is projected above a display on which the content is presented at the first location.

5. The method of claim 1,in which the low-bandwidth visualization comprises a visualization of audio recorded at the second location.

6. A system for augmented presentation of content at a first location, comprising presentation means for presenting the content, visualization means for creating a low-bandwidth visualization of participation of viewers of the content at a second location and projecting means for projecting the low-bandwidth visualization at the first location.

7. The system of claim 6, in which the visualization means comprise a camera arranged to record images of the viewers at the second location at predetermined intervals coupled to a visualizer arranged for computing a difference between two subsequent recorded images, which visualizer is in turn coupled to a transmitter for transmitting said difference to the projecting means, the projecting means being arranged to display the difference as the low-bandwidth visualization.

8. The system of claim 6,in which the visualization means comprise a microphone arranged to record audio at the second location coupled to a visualizer arranged to map the recorded audio to a color value on a given scale, which visualizer is in turn coupled to a transmitter for transmitting the color value to the projecting means, the projecting means being arranged to display a color corresponding to the color value as the low-bandwidth visualization.

9. The system of claim 6, in which the visualization means are connected to the projecting means via the Internet.
